(19) United States
(12) Patent Application Publication
(10) Pub. No.: US 2002/0048343 A1
(43) Pub. Date: Apr. 25, 2002

(54) Three-dimensional image generating method and device and associated radiology apparatus

(76) Inventors: Laurent Launay, Ies Chevreuse (FR); Yves Trousset, Palaiseau (FR); Sebastian Gicquel, Cambridge, MA (US); Regis Vaillant, Villebon sur Yvette (FR)

Correspondence Address: General Electric Company, 3135 Easton Turnpike -W3C, Fairfield, CT, 06431, US

(21) Appl. No.: 09/948,465

(22) Filed: Sep. 6, 2001

(30) Foreign Application Priority Data
Sep. 8, 2000 (FR) 0011486

(51) Int. Cl. H05G 1/64

(52) U.S. Cl. 378/98.12; 378/98.11

(57) ABSTRACT

Method of generating three-dimensional images of an object from at least two series of two-dimensional images comprises a third series of two-dimensional image is generated by subtracting the images of one of the two series of images from the other series; a three-dimensional reconstruction is made from the third series of images in order to obtain a subtracted three-dimensional image; a three-dimensional reconstruction is made from the first series of images in order to obtain a three-dimensional image corresponding to the first series; and a three-dimensional image corresponding to the second series of two-dimensional images is generated. A device for generating the three-dimensional images; a radiology apparatus including the device; a computer program code for carrying out the method; and a support having the program stored therein.

### CROSS REFERENCE TO RELATED APPLICATIONS

This application claims the benefit of a priority under 35 USC 119 to French Patent Application No. 0011486 filed Sep. 8, 2000, the entire contents of which are incorporated by reference.

### BACKGROUND OF THE INVENTION

The present invention is directed to image generation and processing, and particularly to images obtained by means of a radiology apparatus. The invention applies in general to the generation of three-dimensional images, obtained, for example, in radiology, particularly in the medical field, from X-ray imaging devices. The invention is directed to X-ray imaging devices, for example, in the medical, veterinary or industrial field, particularly but not exclusively in vascular imaging.

A radiology apparatus used, for example, in mammography, RAD or RF conventional radiology and neurological or vascular (peripheral or cardiac) radiology is generally composed of: (1) of a radiogenic source comprising an X-ray tube and a collimator for forming and delimiting an X-ray beam; (2) an image receiver, of the radiological image intensifier type, or video camera, or solid-state detector; (3) of a positioner carrying the X-ray tube and collimator assembly on one side and image receiver on the other, movable in space on one or more axes; and (4) a means of positioning the object to be imaged, e.g., patients, such as a table provided with a platform designed to support the object in a desired position, e.g., supine.

A radiology apparatus further comprises means of control of the radiogenic source, making it possible to adjust parameters such as the X-radiation dose, exposure time, high feed voltage, etc., from a means of control of the different motors enabling the radiology apparatus to be displaced on its different axes, as well as the means of positioning the patient and image processing means making possible a display on screen and data storage for two- or three-dimensional images with functions such as a zoom, a translation along one or more perpendicular axes, a rotation on different axes, a subtraction of images or also an extraction of the contour. Those functions are secured by an electronic card subject to different adjustments. A radiology apparatus is shown in EP-A-972,490.

In the field of three-dimensional image reconstruction, reference can be made to documents FR-A-2,656,129 and FR-A-2,779,853.

EP-A-840,253 concerns a method for obtaining a sub-pixel registration of mask and opacified images by match point generation, locally adaptive image-to-image warp generation and log subtraction to generate an angiographic image by so-called “DSA” digital subtraction.

### BRIEF DESCRIPTION OF THE INVENTION

The invention is directed to a method of generating images making possible a better visualization of the structures observed. The invention proposes a method of image processing, in which a contrast medium injected into the organ to be studied, possible vascular implants and, as the case may be, lesions such as calcifications close to an atheromatous plaque can be conveniently observed at the same time.

According to one aspect of the invention, the method of generating three-dimensional images of an object from at least two series of two-dimensional images comprises stages in which a third series of two-dimensional image is generated by subtracting the images of one of the two series of images from the other series, a three-dimensional reconstruction is made from the third series of images in order to obtain a subtracted three-dimensional image, a three-dimensional reconstruction is made from the first series of images in order to obtain a three-dimensional image corresponding to the first series, and a three-dimensional image corresponding to the second series of two-dimensional images is generated.

Three-dimensional images corresponding to the three series of two-dimensional images are thus available with, therefore, a possibility of optimal marking of the structures that are best visualized on any one of the three images.

The first or second series of images is advantageously taken before injection of a contrast medium into the object, and the second or first series of images is respectively taken after injection of the contrast medium into the object. One of the series of images is therefore called “mask” and the other is called “opacified.”

The three three-dimensional images are preferably simultaneously displayed on three screens or three parts of a screen. The contrast medium may therefore be seen, that is, the flow of blood in a vessel on the image subtracted, the lesions and the implants from the mask image, and all of these elements on the opacified image.

In an embodiment of the invention, each image is equipped with a pointer and the movement of the three pointers is made simultaneously and correspondingly. A same structure can thus be marked with a high degree of precision on each of the images.

In an embodiment of the invention, sections of the three three-dimensional images are displayed.

In an embodiment, the three-dimensional image corresponding to the first series of two-dimensional images bears only on a part of the three-dimensional image subtracted. The quantity of data to be processed is thus diminished and computing times are thus reduced. The substracted part can be defined by movement of a pointer. The subtracted part can be automatically defined by location of elements of interest in the three-dimensional image subtracted and enlargement of the elements of interest in order to determine the part.

In an embodiment, the three-dimensional image corresponding to the second series of two-dimensional images is generated by addition of the three-dimensional image subtracted and of the three-dimensional image corresponding to the first series of two-dimensional images. It is, in fact, faster to generate an image by addition or subtraction of two three-dimensional images than by reconstruction of a series of two-dimensional images.

The invention is direct to a device for generating three-dimensional images of an object from at least two series of two-dimensional images. The device comprises a means for generating a third series of two-dimensional images by subtraction of the images of one of the two series of images of the other series, a means for three-dimensional reconstruction from the third series of images in order to obtain a subtracted three-dimensional image, a means for three-dimensional reconstruction of the first series of two-dimensional images in order to obtain a three-dimensional image corresponding to the first series, and a means for generating a three-dimensional image corresponding to the second series of two-dimensional images.

The invention is directed to a radiology apparatus of the type comprising an X-ray beam emitter, a receiver of the X-ray beam after it has cross an object, e.g., an organ to be studied, and an arithmetical unit capable of controlling the emitter and processing data from the receiver. The object can be placed between the receiver and the emitter on the path of the X-ray beam. The apparatus further includes a three-dimensional image generating device, as described above.

The invention is directed to a computer program comprising program code means for using the image generating stages, when the program is operating on a computer.

The invention is directed to a support capable of being read by the device for reading the program code means which are stored there and suitable for use of the image generating stages, when the program is operating on a computer.

### BRIEF DESCRIPTION OF THE DRAWING(S)

One aspect of the invention is illustrated by the following figures:

FIG. 1 is a view in perspective of a multi-axis radiology apparatus capable of being used for application of the method;

FIGS. 2 to 5 are flow charts of stages of the method; and

FIGS. 6 to 8 are examples of images obtained by the method.

### DETAILED DESCRIPTION OF THE INVENTION

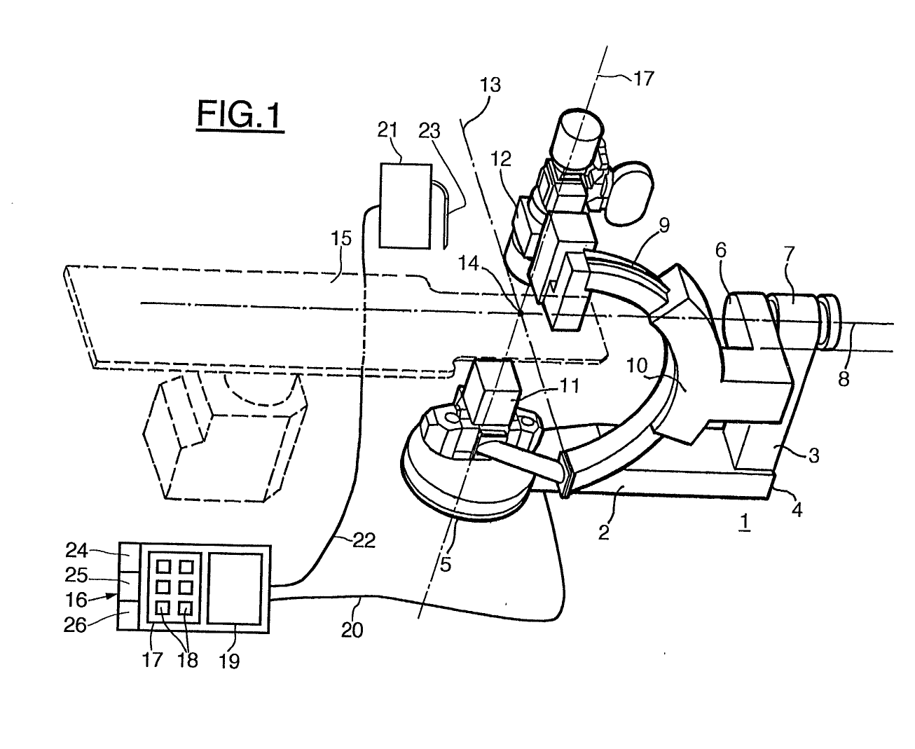

In FIG. 1, the radiology apparatus comprises an L-shaped stand 1 with a roughly horizontal base 2 and a roughly vertical support 3 attached to one end 4 of the base 2. At the opposite end 5, the base 2 embraces an axis of rotation parallel to the support 3 and on which the stand is capable of turning. A support arm 6 is attached by a first end to the top 7 of the support 3, rotating on an axis 8. The support arm 6 can have the shape of a bayonet. A C-shaped circular arm 9 is held by another end 10 of the support arm 6. The C-shaped arm 9 is capable of sliding rotating on an axis 13 relative to the end 10 of the support arm 6.

The C-shaped arm 9 supports an X-ray emission means 11 and an X-ray detector 12 in diametrically opposite positions facing each other. The detector 12 has a plane detection surface. The direction of the X-ray beam is determined by a straight line joining a focal point of the emission means 11 to the center of the plane surface of the detector 12.

The axis of rotation of the stand 1, the axis 8 of the support arm 6 and the axis 13 of the C-shaped arm 9 are secant at a point 14 called isocenter. In mid-position, those axes are perpendicular to one another. The axis of the X-ray beam also passes through point 14.

A table 15, provided to accommodate a patient, possesses a longitudinal orientation aligned with the axis 8 in rest position.

The radiology apparatus comprises a control unit 16 joined by wire connection 20 to the positioner formed by elements 1 to 10, to the X-ray emission means 11 and to the detector 12. The control unit 16 includes processing means, such as a processor, one or more memories, connected to the processor by a communication bus, not represented. The control unit 16 is comprises by a control panel 17 provided with buttons 18 and possibly a control lever not represented, and by a screen 19 for image display and possibly of tactile type.

The radiology apparatus is associated with a contrast medium injection device 21, to which it is joined by wire connection 22. The contrast medium injection device 21 is equipped with a needle 23 and is capable of injecting such product, which is iodine-base, for example, into a patient's blood vessel to allow visualization of the vessels situated below in the direction of blood flow, by rendering the blood more opaque to X-rays than it is naturally.

The radiology apparatus includes a means of subtraction 24 of the images of a series of two-dimensional images from the images of another series, a means of three-dimensional reconstruction 25 from a series of images for obtaining a three-dimensional image, and a means of subtraction 26 of two three-dimensional images for obtaining a subtracted three-dimensional image. The means 24, 25 and 26 will preferably be implemented with software.

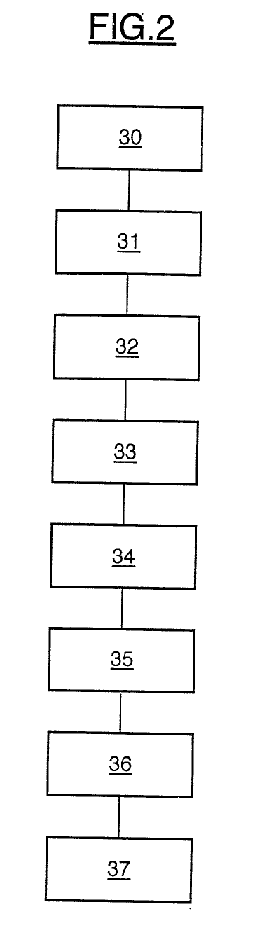

The radiology apparatus is capable of taking a series of two-dimensional images in the course of a path of the positioner. The two-dimensional images thus obtained are memorized in the control unit 16 in order to be then processed in the following manner (see FIG. 2).

In stage 30, the radiology apparatus takes a series of two-dimensional images of a patient's organ along a given path of the positioner and in the absence of contrast medium in the blood stream of the patient. Those two-dimensional mask images are called “2DM”.

In stage 31, the contrast medium is injected manually or automatically, controlled by the control unit of the radiology apparatus. The contrast medium is generally iodine-based and makes it possible to increase markedly the attenuation undergone by the X-rays crossing the blood filled with contrast medium.

In stage 32, a series of two-dimensional images is taken along the same path as in stage 30, with the same angulations, on the same patient in the same position. Those opacified images are taken within a given time after injection of the contrast medium and are called “2DO”.

In stage 33, a subtraction is made between each image of the series of 2DM images and the corresponding image of the series of 2DO images. A series of subtracted images called “2DSA” is thus obtained, on which the blood filled with contrast medium essentially appears; in other words, one can clearly see the passage offered the blood by the blood vessels and other reductions of section of the passage due, among other things, to atheromatous plaques.

In stage 34, a three-dimensional reconstruction is made of the series of 2DSA images in order to obtain a so-called “3DSA” image. For more details on the re-construction technique, reference may be made to the documents cited above.

In stage 35, the three-dimensional reconstruction is made of the series of 2DM two-dimensional mask images in order to obtain a 3DM three-dimensional mask image.

In stage 36, an operation of addition of the 3DSA image obtained in stage 34 to the 3DM image obtained in stage 35 is made in order to obtain a 3DO three-dimensional opacified image.

Finally, in stage 37, three three-dimensional images, 3DSA, 3DM and 3DO are available, and the images are displayed simultaneously on three screens or three parts of a screen. It is also possible to display identical sections, along the same plane, of the three images, 3DSA, 3DM and 3DO, in order to see a particular detail better.

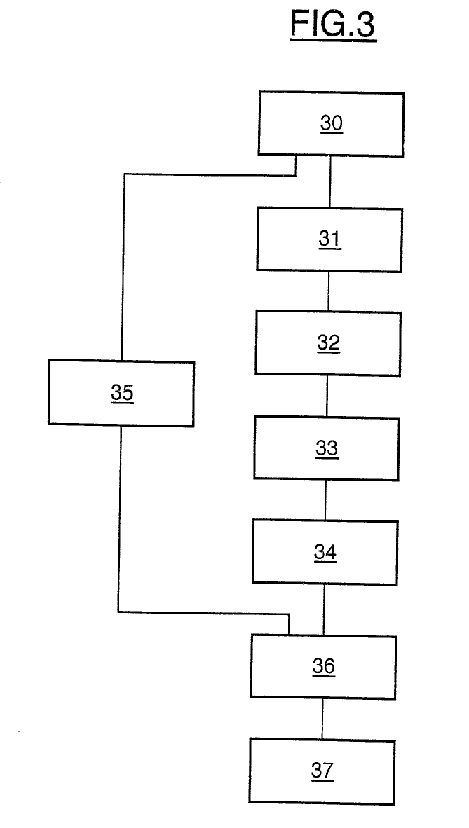

The method illustrated in FIG. 3 is similar to that of FIG. 2, except that the reconstruction stage 35 is carried out from the end of stage 30, particularly during stages 31 to 34, in order to reduce the time necessary for obtaining the three images, 3DSA, 3DM and 3DO.

As a variant, a display of each of the three images, 3DSA, 3DM and 3DO could also be provided for, as soon as they available, namely, from the end of stage 34 for the 3DSA image, from the end of stage 35 for the 3DM image, and at the end of stage 36 for the 3DO image.

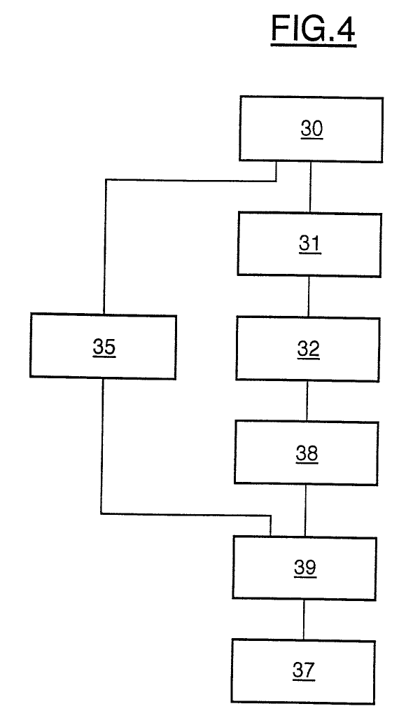

In the variant illustrated in FIG. 4, after stage 32, a stage 38 of three-dimensional reconstruction of the series of 2DO opacified images is carried out in order to obtain a reconstructed 3DO three-dimensional image.

In stage 39, a subtraction of 3DO and 3DM images is carried out in order to obtain a 3DSA subtracted three-dimensional image. One then goes on to the display stage 37.

To reduce the quantity of computations to be made by the microprocessor or microprocessors used, a variant can be provided, as illustrated in FIG. 5, in which, after the 3DSA image reconstruction made in stage 34, one adds a supplementary stage 40 of delimitation of a region of interest, and then a stage 41 of three-dimensional reconstruction of the series of 2DM mask images, in order to obtain a 3DM image, the reconstruction being limited to the region of interest defined in stage 40.

In stage 42, the addition of the 3DSA image and of the 3DM image obtained in stage 41 is made in order to obtain a 3DO opacified three-dimensional image which will tolerate a small error. The error is due to the fact that the subtracted reconstruction (3DSA), to be more rapid, is calculated also on a region limited in space. That region is defined by means of a threshold on reconstructed intensity values, and is therefore different from that defined in stage 40. Consequently, the final reconstruction (sum of the two preceding ones) is exact only at the intersection of the two support regions. For the points included in the support of stage 40 and excluded from the subtracted reconstruction support, an error exists. That error is slight, for it is always less than the threshold value used for obtaining the subtracted reconstruction.

More precisely, the definition of the region of interest made in stage 40 can be carried out manually, the user moving a mouse controlling a pointer present on the screen where the 3DSA image is displayed and defining a closed contour of a part of the 3DSA image. The delimitation can also be made by filtering according to a given gray level threshold, which makes it possible to roughly retain only the blood vessels, and then by an enlargement operation, so that the voxels are taken into account, whose distance to the blood vessels marked is less than a predetermined value. Lesions can thus be encompassed with a great degree of certainty and, notably, calcifications, close to the blood vessels, as well as possible vascular implants, also called “stent” in English.

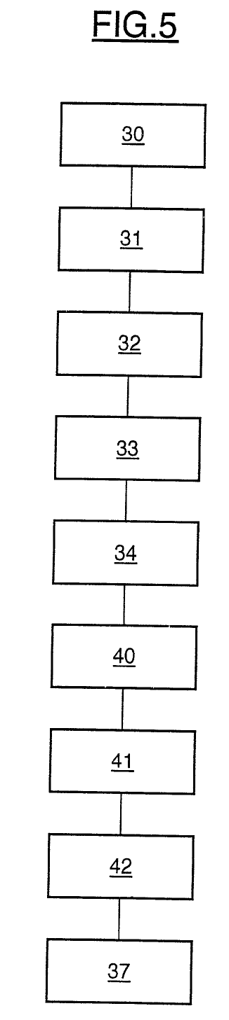

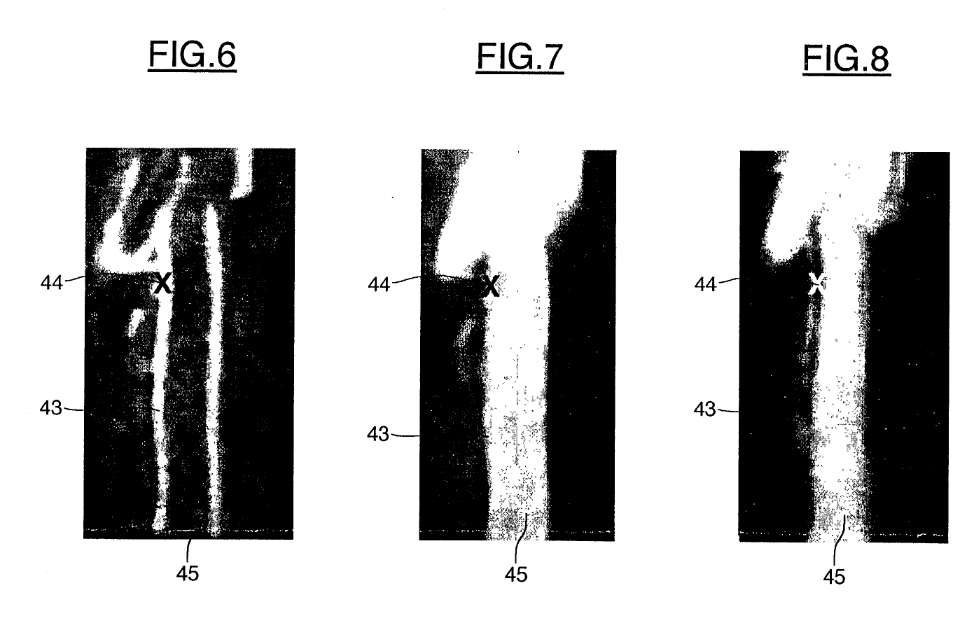

FIGS. 6, 7 and 8 are respectively examples of sections of 3DM, 3DO and 3DSA images. The sections of 3DM, 3DO and 3DSA images can be displayed at the same time on the same screen. The section was made along the axis of a vessel equipped with a vascular implant 43.

On the section of the 3DM image, the generally tubular vascular implant 43 appears light on a dark background. The implant 43 is positioned inside a blood vessel, the walls of which are barely visible. An X-shaped pointer 44 is provided in order to be controlled by the user, for example, by means of a mouse not represented. The pointer 44 is positioned here on the implant 43.

On the section of the 3DO image, the implant 43 appears light on a dark back-ground together with the contrast medium which weds the shape of the interior volume 45 of the blood vessels. The implant 43 and the interior volume 45 are hard to distinguish. The pointer 44 is positioned here on the implant 43, at the same coordinates as on the section of the 3DM image.

On the section of the 3DSA image, the contrast medium which weds the shape of the interior volume 45 of the blood vessels appears light on a dark background. The implant 43 is barely visible. The pointer 44 is positioned here on the implant 43, at the same coordinates as on the section of the 3DM image. It is evident that the pointer 44 is positioned outside the volume 45.

The pointer 44 makes possible a precise matching of the structures observed on the three sections and use of all the information present on the three sections. If the pointer 44 is moved, the movement will be identical on the three sections, for the pointer 44 possesses identical coordinates on the three sections. In case the sections are present on different scales, the pointer 44 will always possess identical coordinates on the three sections.

The user of the radiology apparatus is able to benefit from three three-dimensional images obtained by performing only two reconstruction operations, which saves on computing capacity, reduces the wait time before image display and makes it possible to use small-size voxels and, therefore, high-definition images.

Furthermore, the limitation of the second three-dimensional reconstruction to just the regions of interest makes it possible to reduce also the volume of computations and to enhance the advantages mentioned above.

Finally, the presence of pointers with matching of coordinates among the three images makes possible an excellent marking of the structures present in the image.

The 3DO image makes it possible to see the opacified blood, the calcifications and the implants, but often without sharp distinction between the calcifications and the opacified blood, and even sometimes with the implants, depending on their size and radio-opacity. The 3DSA image makes it possible to visualize the opacified blood alone, with a very high image quality. The 3DM image makes it possible to see the calcifications and the implants very conveniently.

The invention can be advantageously used during a radiological examination, in contrast to a scanner type examination which, though supplying good quality images, necessitate the movement of the patient in a specific costly apparatus, which takes time and requires the patient to change rooms and even facilities, which is a serious practical drawback. Furthermore, the spatial resolution of scanner images, along axis Z, is usually inferior to that of the other directions.

Various modifications in structure and/or steps and/or function may be made by one skilled in the art without departing from the scope and extent of the invention as recited in the claims.

What is claimed is:

1. The method of generating three-dimensional images of an object from at least two series of two-dimensional images comprising the steps of:
generating a third series of two-dimensional image by subtracting the images of one of the two series of images from the other series;
forming a three-dimensional reconstruction from the third series of images in order to obtain a subtracted three-dimensional image;
forming a three-dimensional reconstruction from the first series of images in order to obtain a three-dimensional image corresponding to the first series; and
generating a three-dimensional image corresponding to the second series of two-dimensional images.

2. The method according to claim 1, in which the first or the second series of images is taken before the injection of a contrast medium into the object, and the second or first series of images is respectively taken after the injection of the contrast medium into the object.

3. The method according to claim 1, in which the three three-dimensional images are simultaneously displayed on three screens or three parts of a screen.

4. The method according to claim 2, in which the three three-dimensional images are simultaneously displayed on three screens or three parts of a screen.

5. The method according to claim 3, in which each image is equipped with a pointer and the movement of the three pointers is made simultaneously and correspondingly.

6. The method according to claim 4, in which each image is equipped with a pointer and the movement of the three pointers is made simultaneously and correspondingly.

7. The method according to claim 1 in which sections of the three three-dimensional images are displayed.

8. The method according to claim 1 in which the three-dimensional image corresponding to the first series of images bears only on a part of the subtracted three-dimensional image.

9. The method according to claim 8, in which the part is defined by movement of a pointer.

10. The method according to claim 8, in which the part is automatically defined by:
location of elements of interest in the subtracted three-dimensional image,
enlargement of the elements of interest in order to determine the part.

11. The method according to claim 1 in which the three-dimensional image corresponding to the second series of two-dimensional images is generated by addition of the subtracted three-dimensional image and of the three-dimensional image corresponding to the first series of two-dimensional images.

12. A device for generating three-dimensional images of an object from at least two series of two-dimensional images comprising”
means for generating a third series of two-dimensional images by subtraction of the images of one of the two series of images of the other series;
a means for three-dimensional reconstruction from the third series of images in order to obtain a subtracted three-dimensional image;
a means for three-dimensional reconstruction of the first series of two-dimensional images in order to obtain a three-dimensional image corresponding to the first series; and
a means for generating a three-dimensional image corresponding to the second series of two-dimensional images.

13. A radiology apparatus comprising:
means providing a radiation source;
means for detecting the radiation source;
means for rotating the source and the detector relative to an object to be scanned; and
means for generating an image from the scanning comprising:
a device for generating three-dimensional images of an object from at least two series of two-dimensional images comprising”
means for generating a third series of two-dimensional images by subtraction of the images of one of the two series of images of the other series;
a means for three-dimensional reconstruction from the third series of images in order to obtain a subtracted three-dimensional image;
a means for three-dimensional reconstruction of the first series of two-dimensional images in order to obtain a three-dimensional image corresponding to the first series; and
a means for generating a three-dimensional image corresponding to the second series of two-dimensional images.

14. Computer program comprising program code means for using the stages of the method according to claim 1 when the program is operating on a computer.

15. A support capable of being read by the device for reading a program code means which are stored therein and suitable for use of the stages of the method according to claim 1 when the program is operating on a computer.
